(19) United States
(12) Patent Application Publication
(10) Pub. No.: US 2026/0121690 A1
(43) Pub. Date: Apr. 30, 2026

(54) APPARATUS AND METHOD FOR CONFIGURATING BEAM SETTING AND CONTROL SIGNAL BASED ON RECONFIGURABLE INTELLIGENCE SURFACE IN WIRELESS COMMUNICATION SYSTEM

(71) Applicant: Electronics and Telecommunications Research Institute, Daejeon (KR)

(72) Inventors: Seon-Ae KIM, Daejeon (KR); Junhyeong KIM, Daejeon (KR); Hee Sang CHUNG, Daejeon (KR); Sung woo CHOI, Daejeon (KR)

(21) Appl. No.: 18/936,572

(22) Filed: Nov. 4, 2024

(30) Foreign Application Priority Data
Nov. 1, 2023 (KR) 10-2023-0149180
Oct. 29, 2024 (KR) 10-2024-0149293

(51) Int. Cl. H04B 7/04; H04W 72/0446

(52) U.S. Cl. CPC H04B 7/04013; H04W 72/0446

(57) ABSTRACT

Proposed are an apparatus and a method for configuring beam setting and a control signal on the basis of an RIS in a wireless communication system. An operation method performed by a reconfigurable intelligence surface (RIS) operating in a communication path between a base station and a user equipment (UE) in a wireless communication system includes dynamically optimizing, by the RIS on the basis of a control signal received from the base station, a reflection pattern and transmitting the reflection pattern to the user equipment, and restoring communication by setting an alternate path according to the control signal received from the base station when the user equipment moves or the path is blocked due to an environment change.

### TECHNOLOGY FIELD

The present disclosure relates generally to a wireless communication system. More particularly, the present disclosure relates to an apparatus and a method for configuring beam setting and a control signal on the basis of an RIS in a wireless communication system.

### BACKGROUND OF THE DISCLOSURE

Next-generation 5G and 6G wireless communication systems use high-frequency bands, such as millimeter wave (mmWave) and terahertz (THz) bands, for ultra-high-speed data transmission. However, these high-frequency bands have problems that signals are easily attenuated in the air and propagation is blocked by obstacles. To solve the problems, multiple antennas and beamforming technology are applied, but at the cost of increased cost and complexity. To address these issues, there is a need for a technology capable of flexibly managing a new wireless channel environment.

### CONTENT OF THE INVENTION

### The Object of the Invention

The present disclosure is directed to providing an apparatus and a method for configurating beam setting and a control signal on the basis of a reconfigurable intelligence surface (RIS) in a wireless communication system.

In addition, the present disclosure is directed to providing an apparatus and a method for setting an optimal beam between a transmitter and a receiver on the basis of an RIS in a wireless communication system.

In addition, the present disclosure is directed to providing an apparatus and a method for managing multiple beams efficiently on the basis of an RIS in a wireless communication system.

In addition, the present disclosure is directed to providing an apparatus and a method for quickly finding an alternative path and restoring communication on the basis of an RIS in a wireless communication system in a situation where communication is interrupted.

### Technical Object of the Invention

According to various embodiments of the present disclosure, there is provided an operation method performed by a reconfigurable intelligence surface (RIS) operating in a communication path between a base station and a user equipment (UE) in a wireless communication system, the operation method including: dynamically optimizing, by the RIS on the basis of a control signal received from the base station, a reflection pattern and transmitting the reflection pattern to the user equipment; and restoring, when the user equipment moves or the path is blocked due to an environment change, communication by setting an alternate path according to the control signal received from the base station.

According to various embodiments of the present disclosure, there is provided an operation method performed by a base station (BS) communicating with a reconfigurable intelligence surface (RIS) in a wireless communication system, the operation method including: setting a beam to be transmitted to a user equipment (UE); transmitting the beam to the RIS for transmission to the user equipment through reflection or refraction; setting an alternate path through the RIS when beam quality information received from the user equipment is equal to or less than a predetermined criterion; and restoring communication through the alternate path.

According to various embodiments of the present disclosure, there is provided an operation method performed by a user equipment (UE) communicating with a reconfigurable intelligence surface (RIS) in a wireless communication system, the operation method including: receiving, by the user equipment, a control signal transmitted from a base station (BS); measuring, on the basis of the control signal, quality of a beam reflecting from the RIS; and requesting the base station to set an alternate path when information on the measured quality is equal to or less than a predetermined criterion.

According to various embodiments of the present disclosure, there is provided a reconfigurable intelligence surface (RIS) operating in a communication path between a base station and a user equipment (UE) in a wireless communication system, the RIS including: a transceiver; and a controller operably connected to the transceiver, wherein the controller of the RIS is configured to dynamically optimize a reflection pattern on the basis of a control signal received from the base station and transmit the reflection pattern to the user equipment, and restore communication by setting an alternate path according to the control signal received from the base station when the user equipment moves or the path is blocked due to an environment change.

### Effect of the Invention

The apparatus and the method according to various embodiments of the present disclosure reduce the complexity of a control signal transmitted by a base station (BS), a reconfigurable intelligence surface (RIS), and a user equipment (UE) for beam management, thereby achieving efficient beam management for multiple RISs in a wireless communication network.

Effects that may be obtained from the present disclosure will not be limited to only the above described effects. In addition, other effects which are not described herein will become apparent to those skilled in the art from the following description.

### BRIEF DESCRIPTION OF THE DRAWINGS

FIG. 1 shows an example of an RIS-based wireless communication system, according to various embodiments of the present disclosure.

FIG. 2 shows an example for configuring a base station transmission beam in the direction of a user equipment, according to an embodiment of the present disclosure.

FIG. 3 shows an example for configuring a base station transmission beam in the direction of an RIS, according to an embodiment of the present disclosure.

FIG. 4 shows an example of change in the received signal power in a user equipment according to an embodiment of the present disclosure.

FIG. 5 shows an example of the configuration of a control signal for beam search between a base station, an RIS, and a user equipment, according to an embodiment of the present disclosure.

FIG. 6 shows another example of the configuration of a control signal for beam search between a base station, an RIS, and a user equipment, according to an embodiment of the present disclosure.

FIG. 7 shows still another example of the configuration of a control signal for beam search between a base station, an RIS, and a user equipment, according to an embodiment of the present disclosure.

FIG. 8 shows an example of beam management when a single base station supports a plurality of RISs, according to an embodiment of the present disclosure.

FIG. 9 shows an example for restoring communication through a base station-RIS-UE link, according to an embodiment of the present disclosure.

FIG. 10 shows an example of a beam transmission and reception procedure of a base station, an RIS, and a UE, according to an embodiment of the present disclosure.

FIG. 11 shows an example of a procedure for RIS beam setting and switching to a base station-RIS-user equipment link, according to an embodiment of the present disclosure.

FIG. 12 shows a configuration diagram of a base station in a wireless communication system according to various embodiments of the present disclosure.

FIG. 13 shows a configuration diagram of an RIS or a user equipment in a wireless communication system according to various embodiments of the present disclosure.

### DETAILED DESCRIPTION OF THE EMBODIMENTS

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for configuring beam setting and a control signal on the basis of an RIS in a wireless communication system. Specifically, the present disclosure describes a technology for efficient beam management for multiple reconfigurable intelligence surfaces (RISs) in a wireless communication network by reducing the complexity of a control signal transmitted by a base station (BS), a reconfigurable intelligence surface (RIS), and a user equipment (UE) for beam management (BM) in a wireless communication system.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

Millimetre wave band communications are considered a solution that satisfies ultra-wideband/ultra-low latency service requirements of the 5G standard due to their ability to deliver high-capacity transmission rates of several Gbps or greater by using high frequency bandwidths. However, for 5G and 6G communications using true millimetre wave or THz bands to be commercially viable, there is a need for technologies to overcome propagation characteristics such as propagation attenuation and straightness, which are stronger at higher frequencies, and to operate flexibly.

Therefore, in order to overcome these shortcomings, the 5G NR standard defines the application of beamforming technology using multiple antennas to a base station and a user equipment, and beam management and beam operation procedures to efficiently manage the technology. In addition, technologies, such as 5G small cell and relay technologies, have been introduced to make up for short communication coverage and to extend propagation in shaded areas. However, these technologies can be costly to the user. In addition, as the number of installed nodes increases, the propagation interference increases dramatically, which can eventually reduce the throughput of the overall communication network.

A reconfigurable intelligence surface (RIS) is a planar surface composed of multiple passive reflection elements, and is a new form of antenna technology that independently adjusts and reflects the amplitude or phase of a signal incident on each of the reflection elements to flexibly reconfigure a wireless channel between a transmitter device and a receiver device, thereby improving the quality of a received signal or reducing interference between signals.

In addition, the RIS is considered a key candidate technology for 5G-Advanced and 6G communication systems because a cell-based meta surface composed of reconfigurable elements is programmed to artificially reconfigure a wireless propagation environment so that spectral efficiency can be improved at low cost, communication coverage can be extended, and shaded areas can be covered.

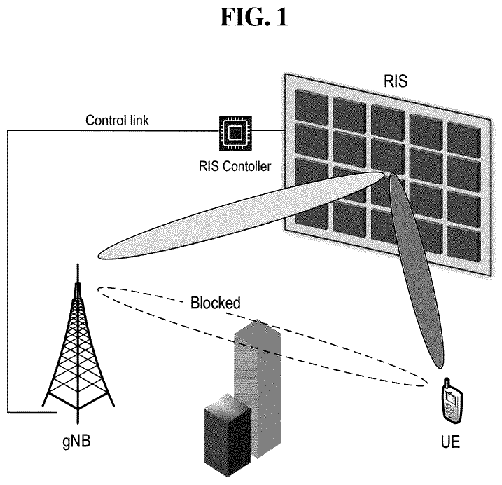

FIG. 1 shows an example of an RIS-based wireless communication system according to various embodiments of the present disclosure.

Referring to FIG. 1, in the RIS-based wireless communication system, when there are propagation obstacles in a direct path between transmission and reception, especially in a mobile communication system using a frequency band having a short wavelength, such as mm-wave, severe path loss may cause communication disconnection due to a signal blocking phenomenon by the propagation obstacles. Herein, a base station (e.g., gNB) forms a separate communication link through an RIS configured in the communication network to replace the direct path between transmission and reception, thereby supporting uninterrupted communication. However, in order to increase network efficiency by improving the wireless propagation environment of the communication network through an RIS, a reflection or refraction patten of the RIS elements needs to be optimized first so that the RIS is able to reflect or refract an incident signal in a desired direction. When an RIS is added between a transmitter device and a receiver device, a channel estimator that performs well in an increased wireless channel environment may be required.

In 5G NR, multiple beams are operated as a basic principle, and the standard defines a beam management procedure for alignment of a transmitter (base station) beam and a receiver (user equipment) beam and for beam selection. To this end, the base station periodically transmits a synchronization signal block (SSB) mapped to a beam identifier (ID) while performing beam sweeping. The user equipment may perform reception beam sweeping and receive reception beams to detect a beam pair (pair) having high signal quality. In addition, the PRACH is transmitted at the transmission location associated with the SSB ID and the best beam is reported to the base station, thereby completing beam setting. Afterward, in order to refine a beam into a narrower range, a reference signal for channel state measurement (for example, CSI-RS for a base station, and SRS for a user equipment) is transmitted while narrow beam sweeping is performed, thereby performing fine transmission or reception beam adjustment.

Referring to FIG. 1, in conventional communications, beam setting for a base station (BS) (for example, gNB) and a receiver (UE or user device), or a beam management procedure needs to be performed. However, when an RIS is introduced, beam setting and management for different links between the BS and the RIS, and between the RIS and the User are required.

As described above, reflection from the RIS corresponds to passive beamforming in which a signal incident from the base station is reflected or refracted to the user equipment, so a downlink or uplink signal received from the base station and the UE is influenced by the performance of transmission beamforming, RIS beamforming, or reception beamforming, which is consequently manifested in the received signal-to-noise ratio (SNR), and reference signal received power (RSRP).

Therefore, there is a need to obtain channel state information for a wireless channel reconfigured by the RIS, including reflection elements of the RIS, and for a reflection coefficient estimation method and a channel estimation method for optimizing end-to-end (BS-to-UE) communication performance through the channel state information.

In addition, generally, the RIS does not have an RF chain, so it is difficult to estimate the BS-RIS link and the RIS-user link separated as independent links. In addition, it is necessary to consider an RIS reflection coefficient optimized for the wireless channel environment that varies according to a beam formed through the control of multiple RIS passive elements, so approaches to a channel estimation method and a beam search method need to be applied differently from conventional methods.

A beam optimization method that is expected to be most feasible in RIS-based communications is to fix a beam for either the BS-RIS link or the RIS-user link and find the optimal beam for the other link. In addition, the same process may be applied to the reverse links, alternating beam optimization for two links. This method is suitable for implementation in practical communication systems, compared to methods that mathematically obtain all channel values for the BS and the UE, and for the BS, the RIS, and the UE, and apply a beamforming variable on the basis of the values to find the optimal or suboptimal solution.

However, this method also requires beam measurement values for all combinations of a base station beam and an RIS beam until the optimal beam set is determined, and signals for beam measurement need to be transmitted, thus increasing system overhead. In addition, there are also problems with communication delay or data loss during beam training. In addition, when communication is supported through multiple RISs in one network, these problems may reduce the overall system efficiency.

The present disclosure is directed to providing a method of setting an optimal beam set in an RIS-supportable wireless communication system, a method of configuring a signal with low complexity for beam control, and a wireless link setting method for reducing communication delay.

In describing the configuration of the present disclosure, an access point (AP) of a wireless communication network that supports an RIS may include a device, such as a base station (BS or gNB), which supports a function of a subject for managing access to a wireless network. In addition, a user may include a range of target devices, such as a user equipment (UE) or a user device, which access the wireless network to receive services.

The present disclosure is described using an AP or a base station as a subject for controlling an RIS and managing control information, for example. However, without being limited thereto, the present disclosure is applicable to the case in which a user equipment may perform setting and make a request to the base station or a communication device connected to the RIS performs setting.

The present disclosure relates to a beam setting method for optimizing a beam applied to a base station, an RIS, and a user equipment in a wireless communication system supporting the RIS, and a control method therefor.

As described above, the base station (or AP) and the user equipment may support multiple beams, and may set a beam pair having high signal quality through a beam sweeping function. In addition, the RIS may set a reflection element coefficient for reflecting a signal received from the base station to the user equipment. The RIS may set several reflection beams in advance to reduce the complexity of setting the reflection element coefficient. An RIS controller may store beam information in the same way as a code book, and may perform setting through a wired or wireless control signal of the base station or the user equipment.

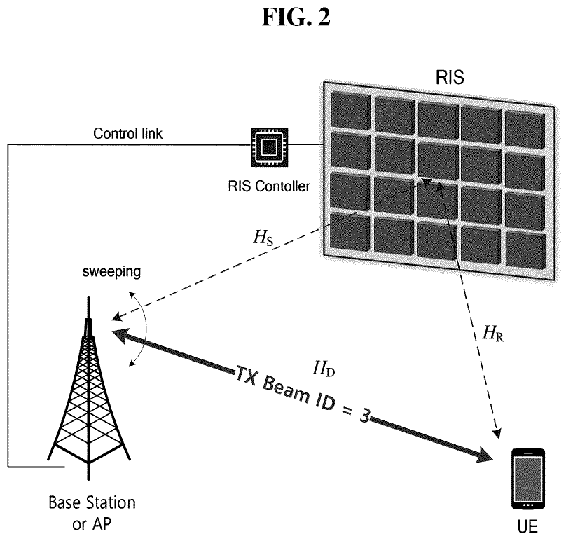

FIG. 2 shows an example for configuring a base station transmission beam in the direction of a user equipment, according to an embodiment of the present disclosure.

Referring to FIG. 2, FIG. 2 shows the example in which when a base station or an AP configures a transmission beam in an RIS-based wireless communication system, the base station and the user equipment form a direct link and a beam aiming at the user equipment, that is, TX_Beam_ID=3 in FIG. 2, is selected as a transmission beam of the base station.

The base station directs a transmission beam toward the user equipment at a particular location to provide the optimal signal power. The base station may adjust a beam dynamically through a beam sweeping process. After setting the transmission beam, the base station may periodically transmit a synchronization signal block and a beam identifier so that the user equipment selects and receives an optimal beam. In this process, the base station provides the user equipment with a beam having a high quality of a received signal among multiple beams, thereby maximizing communication efficiency.

The base station may provide optimal signal quality, simultaneously considering a direct path to the user equipment as well as a reflection path through the RIS. The base station may transmit a signal in the direction of the user equipment by using the transmission beam set as TX_Beam_ID=3. The RIS reflects a signal transmitted from the base station and maintains smooth communication even when the direct path is blocked by obstacles. Through this, the RIS can improve the communication quality between the base station and the user equipment, and can minimize signal attenuation.

Considering the reflection characteristics of the RIS, the base station may select a particular beam during a beam sweeping process, and may set an optimal path. Accordingly, the user equipment receives the signal reflected from the RIS and maximizes the SNR and the reference signal received power (RSRP).

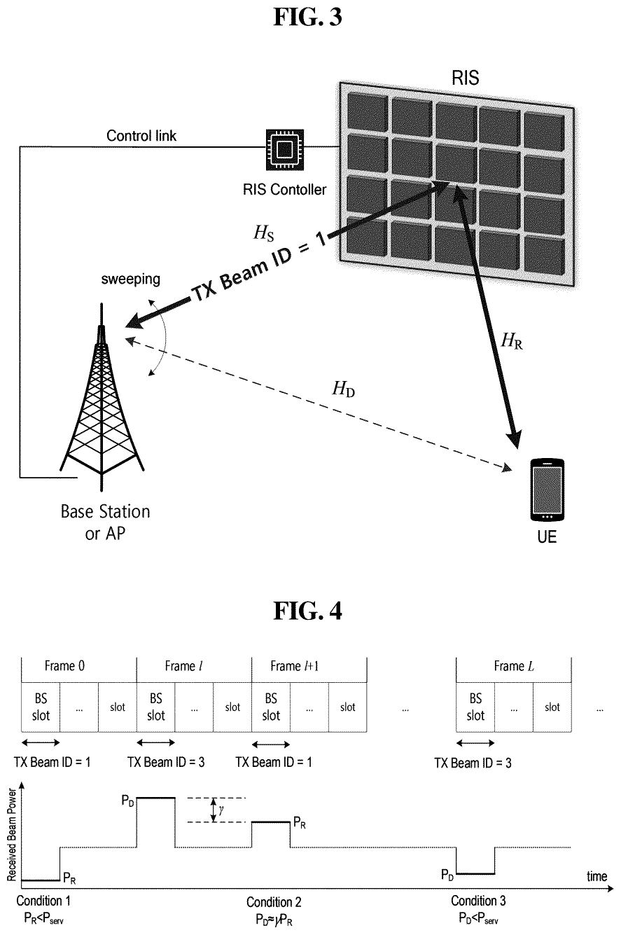

FIG. 3 shows an example for configuring a base station transmission beam in the direction of an RIS, according to an embodiment of the present disclosure.

Referring to FIG. 3, FIG. 3 shows the example in which when a base station or an AP configures a transmission beam in an RIS-based wireless communication system, a link between the base station and the RIS and a link between the RIS and the user equipment are formed through the RIS installed within the wireless communication network, and a base station transmission beam, that is, TX_Beam_ID=1 in FIG. 3, is set to be directed toward the RIS.

Including a base station (e.g., mobile base station) or an RIS installed on a mobile device, the base station may receive the location of the RIS or installation information having a similar function through the RIS controller in a wired or wireless manner. On the basis of this information, the base station may set a beam that may be transmitted in the direction of the RIS among N transmission beams as a base station-RIS transmission beam, and may transmit RIS information to the user equipment through the SSB used for the above-described beam transmission.

The base station directs a beam set with the transmission beam identifier TX_Beam_ID=1 toward the RIS, thereby optimizing the communication quality between transmission and reception. The base station may search reflection elements through transmission beam sweeping, and may set an optimal signal path. For example, the RIS of FIG. 3 is configured in a 5×4 array, and each reflection element is capable of independently adjusting the amplitude and phase of a signal and reflecting a beam in a particular direction. Through this, even when a signal transmitted from the base station is blocked by propagation obstacles, the RIS provides an alternate path to minimize signal loss and maintain communication quality.

The base station may set a reflection pattern through a control signal for the RIS. The control signal transmitted from the base station instructs the amplitude and phase adjustment of the reflection elements so that the RIS reflects a transmitted signal in an optimized path. The base station periodically transmits a control signal to enable the RIS to dynamically adjust the reflection pattern, which may contribute to improvement in communication quality in a multipath environment. The reflection elements of the RIS are in conjunction with a transmission beam of the base station to focus a signal in a particular direction, and the reflection elements are managed in a code book manner and various reflection patterns may be preset.

Synchronization between the base station and the RIS may be an important factor in ensuring the accuracy of signal transmission. The base station may periodically transmit the SSB. The RIS may receive a synchronization signal block to adjust a reflection pattern. The SSB may be transmitted having a transmission beam identifier (TX_Beam_ID) and may be received by the user equipment. Through this, the RIS may support a beam transmitted from the base station to be reflected in an optimal path. This synchronization process is important in a network environment in which multiple RISs are operated, and may minimize delay in communication signals and prevent signal loss through smooth cooperation between the base station and the RISs.

Referring to FIG. 3, FIG. 3 shows setting an optimal beam path through interaction between the base station, the RIS, and the user equipment. The base station may direct a transmission beam to the RIS, and the RIS may transmit a signal to the user equipment through a reflection pattern. Herein, the base station and the RIS may communicate continuously through a control signal. In addition, the base station and the RIS may adjust a reflection pattern and a beam path on the basis of a feedback signal received from the user equipment. The interaction between the base station, the RIS, and the user equipment may minimize signal loss even in a multipath environment, and may maximize the efficiency of the communication network.

In order to minimize communication delay and signal loss that may occur in the signal transmission process between the base station and the RIS, the base station may manage the beam sweeping process efficiently. The RIS may adjust a reflection pattern on the basis of a reference signal received from the base station, thus reducing communication delay and preventing signal loss. In particular, even when the user equipment is moving or there are propagation obstacles, a communication path may be quickly reset using a reflection signal through the RIS, thereby greatly improving real-time communication performance.

According to an embodiment, in the embodiments of FIGS. 2 and 3, the received signal power at the user equipment for the base station-user equipment link and the base station-RIS-user equipment link may be determined by the following three conditions.
Condition 1) P_{D}>P_{R}∧P_{R}<Pₛₑᵣᵥ, when the RIS is off
Condition 2) P_{D}≃γP_{R}, when the RIS is on
Condition 3) P_{D}<P_{R}∧P_{D}<Pₛₑᵣᵥ, when the direct link is blocked

FIG. 4 shows an example of change in the received signal power in a user equipment according to an embodiment of the present disclosure. Specifically, FIG. 4 shows the change in received power according to a state in which the RIS is off, a state in which the RIS is on, and a state in which the direct path is blocked.

A first condition (condition 1) may be the state in which the RIS is off. This means that a signal is received in the direct path between the base station and the user equipment, and the received power may remain the state P_{R}<Pₛₑᵣᵥ. Specifically, when the RIS is inactive, a signal between the base station and the user equipment may be forwarded through the direct path. Herein, the received power P_{D} may depend on a signal received through the direct path. The reflection signal P_{R} may have a small value. In this condition, when there are no propagation obstacles, a signal is stably received, but when there are obstacles, signal blocking may occur.

A second condition (condition 2) is the state in which the RIS is active, and a signal transmitted from the base station is reflected from the RIS and forwarded to the user equipment. The received power may be adjusted to the state P_{D}≅γP_{R}. Specifically, when the RIS is active, a signal transmitted from the base station may be reflected from the RIS and forwarded to the user equipment. Herein, with the received power P_{D}≅γP_{R}, the ratio of a signal received through the reflection path and the ratio of a signal received through the direct path are almost equal. In this state, the SNR and the RSRP may be improved, and even in the presence of propagation obstacles, a signal is forwarded in a detour path through the RIS, thereby improving communication quality.

A third condition (condition 3) is the state in which the direct path is blocked, and the reflection path through the RIS may be used as the only communication path. The received power may remain the state P_{D}<Pₛₑᵣᵥ. Specifically, when the direct path is blocked, communication between the base station and the user equipment is performed only through the RIS reflection path. Herein, the received power is in the state P_{D}<Pₛₑᵣᵥ, and the reflection path is used as the only signal transmission path. Even in this situation, the RIS sets the optimal path through the reflection pattern to maintain communication. In this condition, the RIS plays an important role in maintaining the quality of service (QoS), and a reflection beam is quickly adjusted to minimize communication loss.

Referring to FIG. 4, in the present disclosure, the activation of the RIS path (or the link via the RIS) may be set through the received power or SNR of the path received through the RIS according to the above-described three conditions (the state in which the RIS is off, the state in which the RIS is on, and the state in which the direct path is blocked).

(1) The base station may configure and transmit an RIS indicator or RIS zone (GPS) information that may be recognized as the RIS path through a broadcast channel or a control channel that may forward information on TX_Beam_ID expected to be transmitted through the RIS, for example, the MIB with functions such as beam information and cell information, such as the SSB of the NR.

(2) In the example of FIG. 4, the user equipment may perform a process for activating the link via the RIS when the ratio between the received power of TX_Beam_ID=3 and the received power of TX_Beam_ID=1 is received within a particular range γ. For example, the received power ratio γ may be set to a range in which the received power of the base station-RIS-user equipment link may satisfy QoS compared to the received power of the base station-user equipment direct link. Although a signal is received through the base station-RIS-user equipment link, when a channel state does not satisfy the QoS of data, the user equipment may recognize the RIS as inactive or may make a request to the base station for other beam information. (Same as Condition 1).

(3) If the user equipment detects RIS information from the MIB received with TX_Beam_ID=1 according to the procedure in (2), the user equipment may transmit RIS activation information through the PRACH or control channel. Herein, the RIS activation information may be interpreted as meaning that the base station-RIS-user equipment link may be activated. For example, the user equipment may determine the transmission beam ID to be 3 due to the high signal power PD received through the direct link, and transmit the PRACH sequence mapped to TX_Beam_ID=3 to the corresponding symbol transmission section. However, in the proposed method, the PRACH sequence mapped to TX_Beam_ID=1 is transmitted to the PRACH transmission section for TX_Beam_ID=3 to transmit activation information of the link via the RIS for TX_Beam_ID=1.

(4) The base station may trigger a procedure for RIS beam control through the RIS activation information transmitted from the user equipment.

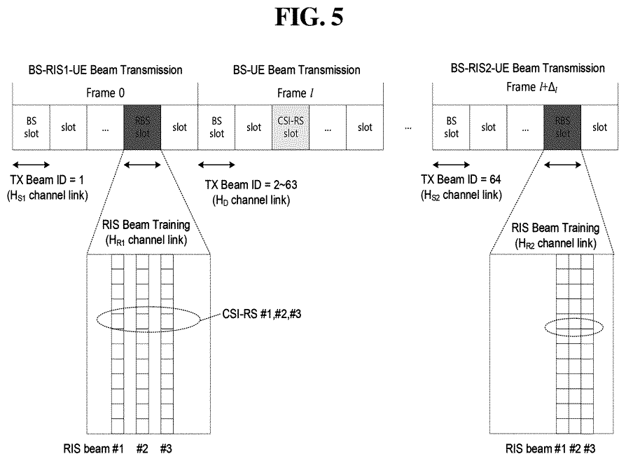

FIG. 5 shows an example of the configuration of a control signal for beam search between a base station, an RIS, and a user equipment, according to an embodiment of the present disclosure.

Referring to FIG. 5, for the above-described RIS activation method, the base station and the RIS or RIS controller may share installation information and control information of the RIS in a wired or wireless manner. Through the RIS installation information, the base station may allocate a transmission beam ID (TX_Beam_ID) for RIS reflection in advance. Through the RIS installation information, the base station allocates K beams among N beams as a beam region for the RIS, reducing the complexity of base station-RIS beam search.

In addition, by broadcasting RIS information to the user equipment through the SSB, the user equipment may recognize time synchronization, such as slots and frames for RIS beam training. Through this, a BS-RIS-UE beam search section and a BS-UE beam search section may be temporally separated as shown in FIG. 5.

Referring to FIG. 5, an example of signal design for BS-RIS-UE beam search and BS-UE beam search is shown. In FIG. 5, a slot for base station transmission beam sweeping is called beam sweeping (BS)_slot, and a slot for RIS beam training is called RIS beam sweeping (RBS)_slot. In the present disclosure, the purpose of operating BS_slot and RBS_slot separately may assume an environment in which base station-RIS beam sweeping minimizes the number of SSB transmissions for RIS beam training in the base station beam sweeping procedure and channel change between the base station and the RIS is slow fading compared to channel change between the RIS and the UE.

Therefore, considering that base station-RIS beam setting is valid within one frame, RBS_slot composed of reference signals is operated within the same frame to reduce data transmission loss caused by frequent transmission of the SSB for base station-RIS-UE beam search.

RBS_slot may update a beam provided by the RIS according to the movement of the user equipment, and may be configured for RIS beam sweeping or training to set an optimal beam. In the present disclosure, RBS_slot may be operated separately from transmission of a CSI reference signal transmitted to collect BS-UE channel state information, and RBS_slot may be set in a frame in which a base station-RIS beam performs searching in the direction of the RIS, for example, a frame in which the SSB corresponding to TX_Beam_ID=1 is transmitted in the figure.

The present disclosure provides a method for finding an optimal beam between the RIS and the UE by training an RIS reflection beam when two links between the base station and the UE, and between the base station, the RIS, and the UE are active.

According to an embodiment, RBS_slot may be composed of reference signals, such as CSI-RS for measuring channel state information for M RIS reflection coefficient sets or beam sets.

As shown in FIG. 5, reference signals may be configured to transmit different sequence symbols to distinguish RIS beams with protection intervals therebetween, or transmit different sequences in consecutive symbols without protection intervals to distinguish RIS beams. In addition, the user equipment may find an optimal beam between the RIS and the UE through channel state information of reference signals in RBS_slot received in the same frame as BS_slot for base station-RIS beams. Herein, the base station may transmit information on RBS_slot to the RIS controller. The RIS controller may be configured as a device capable of controlling the RIS in real time. The RIS controller may include a function of receiving a base station synchronization signal block, and may be synchronized by nearby devices. The RIS controller may change an RIS reflection coefficient according to control time in RBS_slot.

Referring to FIG. 5, the base station may perform transmission beam sweeping in BS_slot, and the RIS may set a reflection beam in RBS_slot and forward a signal to the user equipment. The base station may periodically allocate TX_Beam_ID and set a transmission beam. The RIS may form an optimal reflection beam by adjusting the phase and amplitude of reflection elements. This process may be separated into time slots, thereby minimizing data transmission loss and reducing communication delay. BS-RIS beam search and RIS-UE beam training are performed independently, so that communication efficiency and signal quality can be greatly improved.

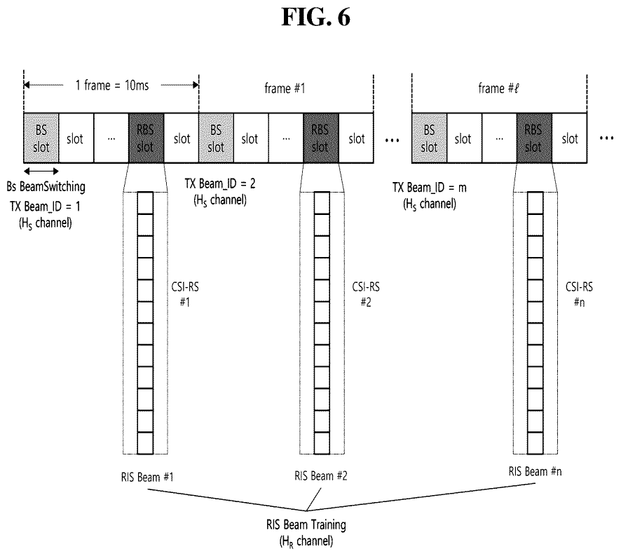

FIG. 6 shows another example of the configuration of a control signal for beam search between a base station, an RIS, and a user equipment, according to an embodiment of the present disclosure.

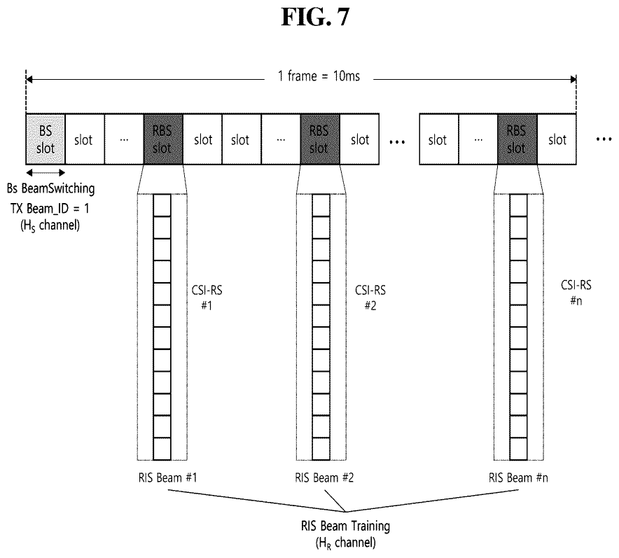

FIG. 7 shows still another example of the configuration of a control signal for beam search between a base station, an RIS, and a user equipment, according to an embodiment of the present disclosure.

Referring to FIG. 6, FIG. 6 shows an example in which BS_slot and RBS_slot are placed together in one frame.

Referring to FIG. 7, FIG. 7 shows an example in which BS_slot and several pieces of RBS_slot are configured in one frame.

Unlike FIG. 5, the structure of FIGS. 6 and 7 corresponds to a structure in which one piece of RBS_slot carries one reference signal (RS), for example, CSI-RS or DMRS, and a pilot signal of another application. Respective RSs may be distinguished by distinguishing factors, such as sequence numbers, for distinguishing signals. Each sequence number and an RIS beam number are mapped, and for each RIS beam, a channel measurement value may be forwarded to a beam management subject (e.g., the base station, the user equipment, and the RIS).

Referring to FIG. 6, FIG. 6 shows an advantageous structure in that when finding an optimal combination of a BS transmission beam and an RIS beam, not all beams are examined, and once a beam set in which a channel measurement value exceeds a threshold value is found, the optimal beam set is quickly determined without examining beam sets for other combinations.

In the case of FIG. 7, FIG. 7 shows an advantageous way to examine M RIS beams for one BS transmission beam to avoid data loss occurring due to a pilot transmitted for RIS beam measurement in one slot. In addition, this structure may be advantageous when the UE does not frequently move and RIS beam search is intermittently performed.

The present disclosure may be efficient for beam management for each RIS in an environment that supports multiple RISs in one network.

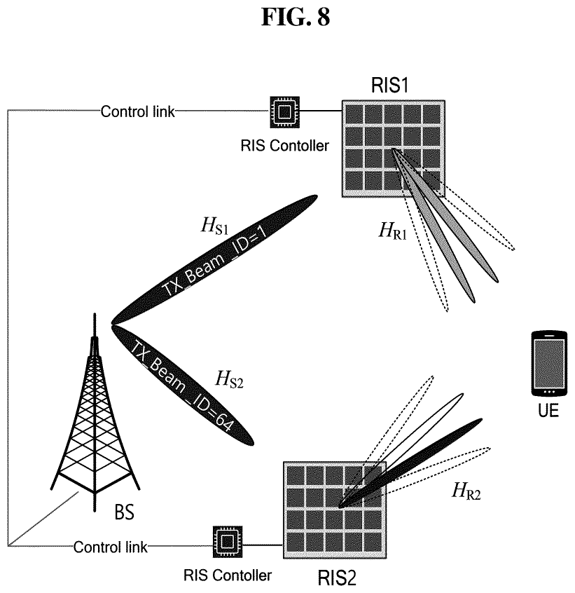

FIG. 8 shows an example of beam management when a single base station supports a plurality of RISs, according to an embodiment of the present disclosure.

Referring to FIG. 8, the base station may allocate TX_Beam_ID for each RIS, and may set transmission beams in the directions of the RISs. For example, TX_Beam_ID=1 may be allocated to RIS1 and TX_Beam_ID=2 may be allocated to RIS2, a beam search procedure between the base station and each RIS may be independently performed. The base station may measure the received signal quality at each RIS through transmission beam sweeping, and may set an optimal beam path. In an environment in which a plurality of RISs are operated, communication overhead may be increased, but the base station may use preset beam paths to reduce the complexity of a beam search procedure and minimize communication overhead. In addition, BS_slot and RBS_slot may be temporally separated to prevent a beam search procedure and data transmission loss, and maximize communication performance.

Specifically, referring to FIGS. 5 and 8, TX_Beam_ID=1 is a base station transmission beam for supporting the base station-RIS1-UE link and TX_Beam_ID=64 is a base station transmission beam directed toward RIS2 in the network. The base station may configure RBS_slot for beam search for the HR1 channel in the frame in which BS_slot for TX_Beam_ID =1 is transmitted, and may configure RBS_slot for beam search for the HR2 channel in the frame in which BS_slot for TX_Beam_ID=64 is transmitted.

The user equipment may collect channel state information (received power, SNR, and CQI) of a reference signal received in the BS-RIS1-UE beam transmission frame, for each RIS beam and may forward beam information for RIS1 to the base station, and may collect channel state information (received power, SNR, and CQI) of a reference signal received in the BS-RIS2-UE beam transmission frame, for each RIS beam and may forward beam information for RIS2 to the base station.

According to an embodiment, when multiple RISs are operated, the base station may continuously perform RIS beam management in an SSB transmission frame for TX_Beam_ID through preset information of base station transmission beam (TX_Beam_ID)-RIS mapping. If the number of RISs to be managed by one base station increases, the cost of TC=(the number of RISs, Q)×(base station transmission beam, N)×(the number of RIS reflection beams, M) may be incurred in order to find base station beams and RIS beams according to a conventional beam management method. Herein, the cost may include time resources for beam management, physical resources including processing delays, and signalling messages required for beam control at the base station, the RISs, and the user equipment. For example, when all beams are controlled using the SSB, SSB transmission signals need to be extended to a range that may include TC. When finding a wide base station beam through the SSB and finding a fine beam through the CSI-RS, high-order control information for distinguishing between the CSI-RS for BS-UE channel information and the CSI-RS for obtaining BS-RIS-UE beam information may be rapidly increased.

According to an embodiment of the present disclosure, through the RIS-related information received during initial access, optimal beams of the base station, the RISs, and the user equipment may be selected while receiving RBS_slot set by a frame in which TX_Beam_ID is received, and a decrease to TC=(the number of RISs, Q)×(base station transmission beam, 1)×(the number of RIS reflection beams, M) may occur.

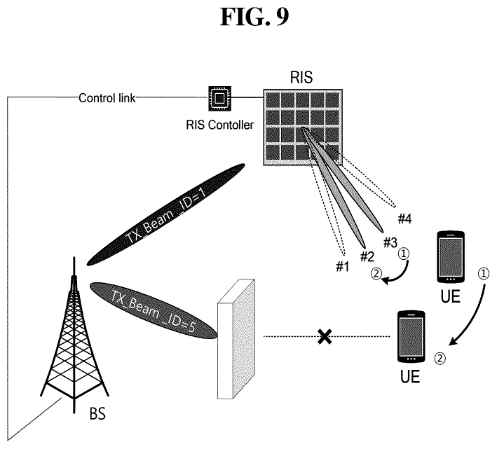

FIG. 9 shows an example for restoring communication through a base station-RIS-UE link, according to an embodiment of the present disclosure.

Referring to FIG. 9, the base station directs transmission beams simultaneously to the RIS and the user equipment, and may use a plurality of beam paths to maximize communication quality. The base station may set a transmission beam on the basis of TX_Beam_ID, and the RIS may reflect a received from the base station and forward the signal to the user equipment. Interaction between the base station and the RIS is performed such that channel state information for each path is collected to select an optimal beam in order to maintain stable communication quality even in a multipath environment.

The base station may periodically adjust a transmission signal through the SSB and the CSI-RS, and the RIS may adjust a reflection beam in real time according to the location and environment change of the user equipment. Through this, a signal is forwarded in an optimal path even when the user equipment moves, so that communication delay and signal loss may be minimized. BS-RIS beam search and RIS-UE reflection path setting are performed in an integrated manner, so that the base station increases communication efficiency through multiple paths and solves a signal attenuation problem caused by propagation obstacles.

Specifically, referring to FIG. 9, FIG. 9 shows an example in which when communication through the BS-UE link is disconnected due to a nearby obstacles (blockage), communication is restored through the BS-RIS-UE link. In FIG. 9, as the user equipment moves from the state \textcircled{1} to the state \textcircled{2}, a base station transmission beam corresponding to TX_Beam_ID =5 is blocked by the neary obstacle and the user equipment may fail to receive a signal.

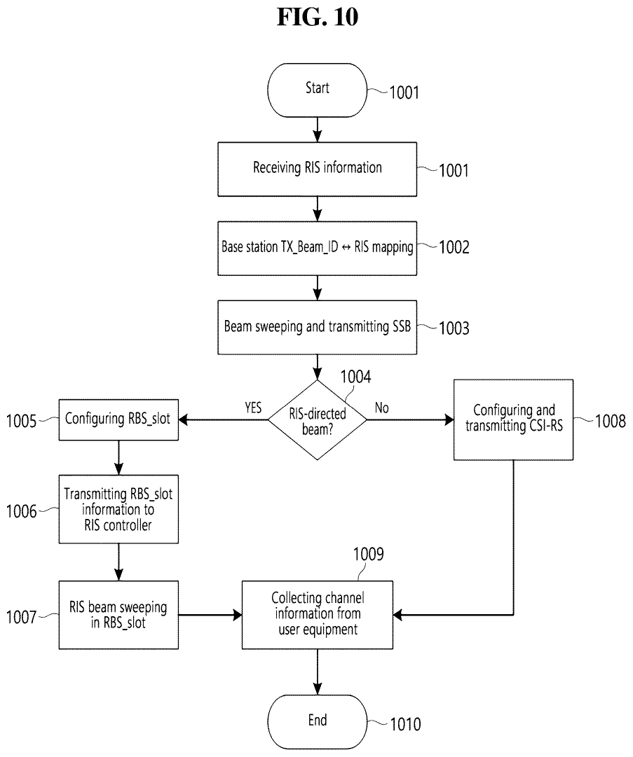

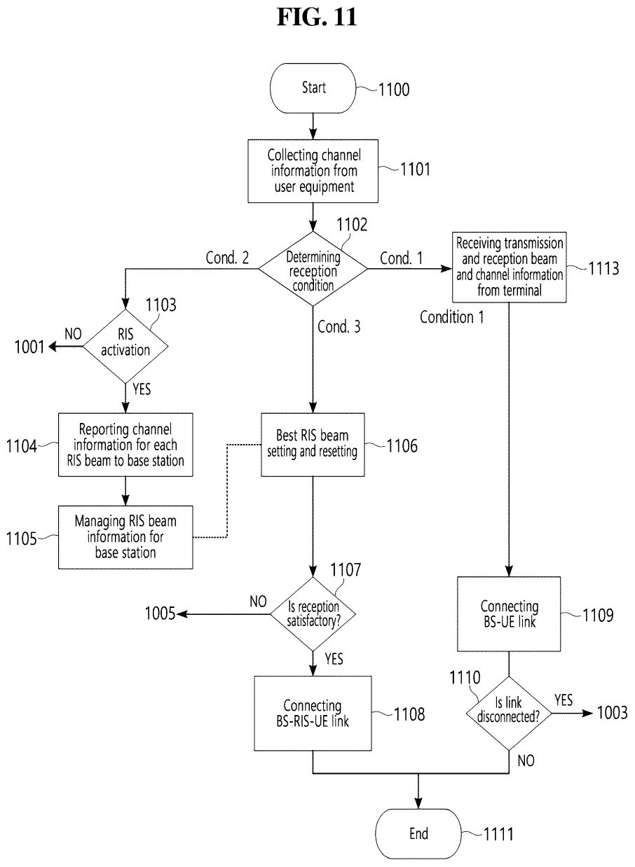

Herein, according to an embodiment of the present disclosure, the user equipment may attempt to access the BS-RIS-UE link configured according to steps 1001 to 1007 of FIG. 10 and steps 1101 to 1108 of FIG. 11, and when the base station does not receive ACK/NACK from the user equipment in the BS-UE link, the base station may change a reception beam to TX_Beam_ID=1 to receive a signal.

As another method, when the base station does not receive ACK/NACK from the user equipment in the BS-UE link and determines that communication has failed, the base station may set communication with the user equipment in the BS-RIS-UE link without delay through channel information of an RIS beam known in advance through RBS_slot of FIGS. 5 to 9, without starting a new beam sweeping for BS-RIS-UE beam tracking. However, as the user equipment moves from the state \textcircled{1} to the state \textcircled{2}, if an optimal (best) RIS beam estimated at the location of \textcircled{1} does not satisfy the QoS when received at the location of \textcircled{2} or if a better beam at the location of \textcircled{2} is to be selected, the BS-RIS-UE beam transmission frame and the RBS_slot of FIG. 5 are configured to update channel information for all beams, and a beam adjust to the current best_beam is first examined for update, thereby reducing beam search overhead.

FIG. 10 shows an example of a beam transmission and reception procedure of a base station, an RIS, and a UE, according to an embodiment of the present disclosure.

Referring to FIG. 10, according to an embodiment of the present disclosure, the base station may collect information of supportable RISs within a wireless communication network in step 1001. In addition, the base station may allocate TX_Beam_ID among N transmission beams to each RIS according to regional information of the base station and the RIS in step 1003.

The base station may configure the SSB mapped to TX_Beam_ID expected to be transmitted in the direction of the RIS by inserting RIS-related information, and may transmit the SSB by alternating the beams corresponding to TX_Beam_ID in temporally separated SSB transmission slots in step 1003.

The base station may determine whether a pre-allocated TX_Beam_ID is a transmission beam for the RIS in step 1004.

When the base station determines that the pre-allocated TX_Beam_ID is a transmission beam for the RIS, the base station may configure RBS_slot in the frame in step 1005. In addition, the base station may forward information on RBS_slot to the RIS controller in step 1006. The RIS may perform RIS beam sweeping in RBS_slot under the control of the RIS controller in step 1007.

Afterward, the base station may collect channel information from the user equipment in step 1009.

When TX_Beam_ID is not a beam allocated for RIS beam search, the base station may perform a conventional beam search procedure in step 1004. That is, the base station may configure and transmit CSI-RS in step 1008. Afterward, the base station may collect channel information from the user equipment in step 1009.

FIG. 11 shows an example of a procedure for RIS beam setting and switching to a base station-RIS-user equipment link, according to an embodiment of the present disclosure.

Referring to FIG. 11, FIG. 11 shows an operation procedure for setting an RIS beam through received channel information collected from the user equipment, and switching to a base station-RIS-UE link.

Referring to FIG. 11, the user equipment may collect channel information in step 1101.

In addition, according to the beam transmission procedure of FIG. 10, the user equipment may determine an RIS active state through the received signal power and SNR (see FIG. 4) according to the reception conditions (e.g., condition 1, condition 2, and condition 3) according to an embodiment of the present disclosure in step 1102. When the reception condition 2 is met, the user equipment may determine that the RIS is active and a signal is received through the RIS in step 1103. The user equipment may collect channel information for each RIS beam with respect to the RIS beam index of the received reference signal, and may transmit RIS beam information in an uplink slot for transmitting feedback to the corresponding slot through the link in service in step 1104. The user equipment may manage the RIS beam information to control the RIS beam when necessary in step 1105.

Back to step 1102, when the reception condition 1 is met, the user equipment may receive transmission and reception beam information for the currently received beam pair in order to report to the base station that data transmission and reception is possible through the base station-user equipment direct link in step 1113.

Afterward, the user equipment may set a base station-user equipment link in step 1109.

In step 1110, when the user equipment continues to fail to demodulate received data, the base station may wait until the timer for waiting to receive ACK/NACK from the user equipment terminates and then resume beam sweeping back in step 1003 of FIG. 10. Herein, the signal power received by the user equipment through a transmission and reception beam is equal to condition 3, and according to an embodiment of the present disclosure, the base station may forward an optimal beam set among collected and managed RIS beams to the RIS controller. When the quality of a signal received through a base station-RIS-user equipment beam is in the range that satisfies the QoS, the user equipment may report this information to the base station and may set a BS-RIS-user equipment link. Herein, a reference signal may be configured such that when the received signal state of a beam most recently selected as an optimal beam (best_beam) set decreases, the next beam training performs searching starting from adjacent beams of the recent best_beam.

In the case of the received condition 3, the user equipment may determine that the direct link is disconnected. Afterward, the base station may perform best RIS beam setting and resetting in step 1106.

Afterward, the user equipment may determine whether the reception state is satisfactory in step 1107. When the reception state is not satisfactory, step 1005 of FIG. 10 make take place.

When the reception state is satisfactory, the user equipment may perform connection through the base station-RIS-user equipment link in step 1108.

According to various embodiments of the present disclosure, a method of setting an optimal beam set in an RIS support wireless communication system reduces the complexity of design and configuration of a control signal transmitted for beam management by a base station, an RIS, and a user equipment, so that beams for multiple RISs in a communication network are efficiently managed and controlled and the system capacity of the entire communication network may be improved. The specific inventive effects or inventive features arising from the present disclosure are as follows.

By setting a base station-RIS beam through management information for an RIS in a communication network, a base station transmission beam management method may simultaneously control an RIS-related beam and a direct beam toward a user equipment (step 1). For RIS reflection beam management, it is possible to dynamically operate the beam management method in step 1 and an RIS beam control section through temporally separated frame, slot, and reference signal configurations, and easily perform beam control, and update RIS beam state information while receiving a data channel (step 2).

Step 2 enables beam information to be transmitted without delay through the direct link (step 3).

Step 3 enables propagation block in the direct link to be quickly dealt with (step 4).

By the features of steps 1 and 2 described above, the present disclosure may simplify signal transmission and communication signaling for beam management for multiple RISs in the communication network, and may support access RIS change according to the mobility of the user equipment, that is, the change of the location of the user equipment, by determining an RIS active state, such as change in the received signal power measured at the user equipment, and by determining the possibility of the use of an RIS for a current reception user equipment by the base station.

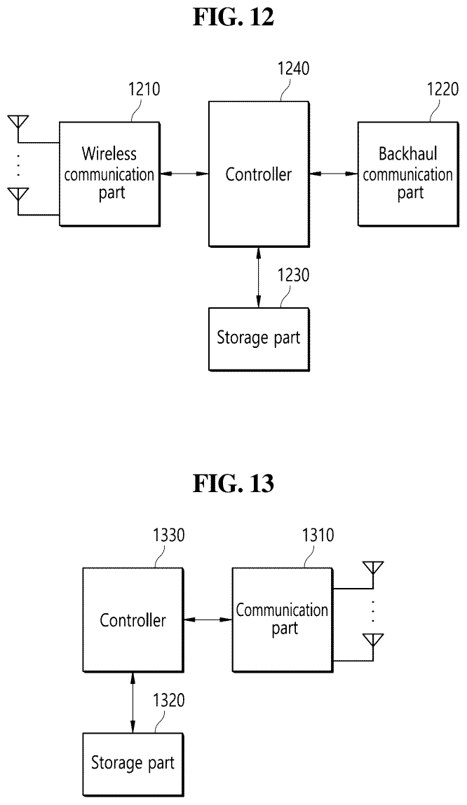

FIG. 12 shows a configuration diagram of a base station in a wireless communication system according to various embodiments of the present disclosure. The configuration illustrated in FIG. 12 may be understood as a configuration of a base station. The terms “˜part”, “˜unit”, and the like used below mean a unit for processing at least one function or operation, and may be implemented by hardware, software, or a combination of hardware and software.

Referring to FIG. 12, a base station may include a wireless communication part 1210, a backhaul communication part 1220, a storage part 1230, and a controller 1240.

The wireless communication part 1210 may transmit and receive wireless signals through a wireless channel. For example, the wireless communication part 1210 may perform a function of conversion between a baseband signal and a bit string according to the physical layer standards of a system. In addition, when transmitting data, the wireless communication part 1210 may generate complex symbols by encoding and modulating a transmission bit string. When receiving data, the wireless communication part 1210 may restore a reception bit string by demodulating and decoding a baseband signal.

In addition, the wireless communication part 1210 may up-convert a baseband signal into a radio frequency (RF) band signal and transmit the RF band signal through an antenna, and may down-convert an RF band signal received through an antenna into a baseband signal. To this end, the wireless communication part 1210 may include a transmission filter, a reception filter, an amplifier, a mixer, an oscillator, a digital-to-analog converter (DAC), and an analog-to-digital converter (ADC).

The wireless communication part 1210 may include multiple transmission and reception paths. The wireless communication part 1210 may include at least one antenna array composed of multiple antenna elements.

In terms of hardware, the wireless communication part 1210 may include a digital unit and an analog unit. The analog unit may include multiple sub-units according to operating power or operating frequency. The digital unit may be realized as at least one processor (e.g., digital signal processor (DSP)).

The wireless communication part 1210 may transmit and receive wireless signals as described above. Accordingly, all or part of the wireless communication part 1210 may be referred to as a “transmitter”, “receiver”, or “transceiver”. In addition, in the following description, transmission and reception performed through a wireless channel may include the above-described processing performed by the wireless communication part 1210.

The backhaul communication part 1220 may provide an interface for performing communication with other nodes in the network. That is, the backhaul communication part 1220 may convert bit strings transmitted from the base station to other nodes, such as other access nodes, other base stations, a parent node, and a core network, into physical signals, and may convert physical signals received from other nodes into bit strings.

The storage part 1230 may store therein data, such as default programs, application programs, and setting information for the operation of the base station. The storage part 1230 may be a volatile memory, a non-volatile memory, or a combination of a volatile memory and a non-volatile memory. In addition, the storage part 1230 may provide stored data according to a request of the controller 1240.

The controller 1240 may control overall operations of the base station. For example, the controller 1240 may transmit and receive signals through the wireless communication part 1210 or the backhaul communication part 1220. In addition, the controller 1240 may record data on the storage part 1230 and may read the data. In addition, the controller 1240 may perform functions of a protocol stack that communication standards require.

To this end, the controller 1240 may include at least one processor.

According to various embodiments of the present disclosure, the controller 1240 may perform control so that the above-described base station performs the operations according to various embodiments.

FIG. 13 shows a configuration diagram of an RIS or a user equipment in a wireless communication system according to various embodiments of the present disclosure. The configuration illustrated in FIG. 13 may be understood as a configuration of an RIS or a user equipment. The terms “˜part”, “˜unit”, and the like used below mean a unit for processing at least one function or operation, and may be implemented by hardware, software, or a combination of hardware and software.

Referring to FIG. 13, a user equipment or RIS may include a communication part 1310, a storage part 1320, and a controller 1330.

The communication part 1310 may perform functions for transmitting and receiving signals through a wireless channel. For example, the communication part 1310 may perform a function of conversion between a baseband signal and a bit string according to the physical layer standards of a system. For example, when transmitting data, the communication part 1310 may generate complex symbols by encoding and modulating a transmission bit string. When receiving data, the communication part 1310 may restore a reception bit string by demodulating and decoding a baseband signal. In addition, the communication part 1310 may up-convert a baseband signal into an RF band signal and transmit the RF band signal through an antenna, and may down-convert an RF band signal received through an antenna into a baseband signal. For example, the communication part 1310 may include a transmission filter, a reception filter, an amplifier, a mixer, an oscillator, a DAC, and an ADC.

In addition, the communication part 1310 may include multiple transmission and reception paths. Furthermore, the communication part 1310 may include at least one antenna array composed of multiple antenna elements. In terms of hardware, the communication part 1310 may be a digital circuit and an analog circuit (for example, a radio frequency integrated circuit (RFIC)). Herein, the digital circuit and the analog circuit may be realized as one package. In addition, the communication part 1310 may include multiple RF chains. Furthermore, the communication part 1310 may perform beamforming.

The communication part 1310 transmits and receives signals as described above. Accordingly, all or part of the communication part 1310 may be referred to as a “transmitter”, “receiver”, or “transceiver”. In addition, in the following description, transmission and reception performed through a wireless channel may be used to mean that the communication part 1310 performs the above-described processing.

The storage part 1320 may store therein data, such as default programs, application programs, and setting information for the operation of the user equipment or RIS. The storage part 1320 may be a volatile memory, a non-volatile memory, or a combination of a volatile memory and a non-volatile memory. In addition, the storage part 1320 may provide stored data according to a request of the controller 1330.

The controller 1330 may control overall operations of the user equipment or RIS. For example, the controller 1330 may transmit and receive signals through the communication part 1310. In addition, the controller 1330 may record data on the storage part 1320 and may read the data. The controller 1330 may perform functions of a protocol stack that communication standards require. To this end, the controller 1330 may include at least one processor or microprocessor, or may be part of a processor. In addition, part of the communication part 1310 and the controller 1330 may be referred to as a communication processor (CP).

According to various embodiments, the controller 1330 may perform control so that the above-described user equipment or RIS performs the operations according to the various embodiments.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, either multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. An operation method performed by a reconfigurable intelligence surface (RIS) operating in a communication path between a base station and a user equipment (UE) in a wireless communication system, the operation method comprising:
dynamically optimizing, by the RIS on the basis of a control signal received from the base station, a reflection pattern and transmitting the reflection pattern to the user equipment; and
restoring, when the user equipment moves or the path is blocked due to an environment change, communication by setting an alternate path according to the control signal received from the base station.

2. The operation method of claim 1, further comprising
dynamically adjusting an amplitude and a phase of a reflection element according to the control signal received from the base station.

3. The operation method of claim 2, wherein the RIS includes a plurality of the reflection elements,
the dynamically adjusting of the amplitude and the phase of the reflection element according to the control signal received from the base station includes controlling the reflection pattern of each of the reflection elements individually by the RIS,
the dynamically adjusting of the amplitude and the phase of the reflection element according to the control signal received from the base station includes optimizing the reflection pattern in real time by the RIS according to movement or a location change of the user equipment, and
the restoring of communication by setting the alternate path according to the control signal received from the base station when the user equipment moves or the path is blocked due to the environment change includes restoring communication by automatically setting the alternate path by the RIS when an obstacle occurs in the communication path between the base station and the user equipment.

4. The operation method of claim 1, wherein the user equipment receives the control signal on the basis of a slot for beam search transmitted from the base station, and
the slot includes a time interval during which beam search between the base station and the RIS is performed.

5. An operation method performed by a base station (BS) communicating with a reconfigurable intelligence surface (RIS) in a wireless communication system, the operation method comprising:
setting a beam to be transmitted to a user equipment (UE);
transmitting the beam to the RIS for transmission to the user equipment through reflection or refraction;
setting an alternate path through the RIS when beam quality information received from the user equipment is equal to or less than a predetermined criterion; and
restoring communication through the alternate path.

6. The operation method of claim 5, wherein the setting of the alternate path through the RIS when the beam quality information received from the user equipment is equal to or less than the predetermined criterion includes updating a reflection pattern of the RIS at particular time intervals on the basis of the beam quality information received from the user equipment.

7. The operation method of claim 5, wherein when communicating with a plurality of the RISs, the base station independently manages a beam allocated to each of the RISs, and
separately controls the reflection pattern of each of the plurality of the RISs,
the setting of the alternate path through the RIS when the beam quality information received from the user equipment is equal to or less than the predetermined criterion includes automatically resetting the reflection path of the RIS when the user equipment moves or an environment change occurs, and
the setting of the alternate path through the RIS when the beam quality information received from the user equipment is equal to or less than the predetermined criterion includes restoring communication by switching to a direct path when performance of a communication path through the RIS is degraded.

8. The operation method of claim 5, wherein the setting of the alternate path through the RIS when the beam quality information received from the user equipment is equal to or less than the predetermined criterion includes automatically resetting the reflection path of the RIS when the user equipment moves or an environment change occurs, and
the setting of the alternate path through the RIS when the beam quality information received from the user equipment is equal to or less than the predetermined criterion includes restoring communication by switching to a direct path when performance of a communication path through the RIS is degraded.

9. The operation method of claim 5, wherein the base station configures a frame including a time interval for beam search and control signal transmission, and
the frame is a slot for performing beam search between the base station and the RIS and a setting procedure.

10. The operation method of claim 5, wherein the base station configures a slot such that beam search between the base station and the RIS and beam search between the RIS and the user equipment are performed simultaneously within the same frame.

11. The operation method of claim 5, wherein the base station configures a plurality of RIS beam search slots within one frame, and
the plurality of slots perform simultaneous beam search for a plurality of the RISs.

12. An operation method performed by a user equipment (UE) communicating with a reconfigurable intelligence surface (RIS) in a wireless communication system, the operation method comprising:
receiving, by the user equipment, a control signal transmitted from a base station (BS);
measuring, on the basis of the control signal, quality of a beam reflecting from the RIS; and
requesting the base station to set an alternate path when information on the measured quality is equal to or less than a predetermined criterion.

13. The operation method of claim 12, wherein the measuring of the quality of the beam reflecting from the RIS on the basis of the control signal includes measuring the quality of the beam on the basis of signal-to-noise ratio (SNR) or reference signal received power (RSRP).

14. The operation method of claim 12, wherein the requesting of the base station to set the alternate path by the user equipment is performed only when the alternate path is a reflection path through the RIS.

15. The operation method of claim 12, further comprising stopping, by the user equipment, using the path through the RIS and switching to a direct path when the quality of the beam is equal to or greater than a particular criterion.

16. The operation method of claim 12, further comprising selecting an optimal path again by periodically monitoring the quality of the beam after the alternate path is set.

17. The operation method of claim 12, wherein the RIS is set such that beam search between the base station and the RIS and beam search between the RIS and the user equipment are performed simultaneously within the same frame in communication between the base station and the user equipment.

18. The operation method of claim 12, wherein the RIS communicates with the base station or the user equipment by using a plurality of beam search slots within one frame.
